(19) United States
(12) Patent Application Publication
(10) Pub. No.: US 2019/0340389 A1
(43) Pub. Date: Nov. 7, 2019

(54) SEARCH DEVICE, MONITORING SYSTEM, AND COMPUTER READABLE MEDIUM

(71) Applicant: MITSUBISHI ELECTRIC CORPORATION, Tokyo (JP)

(72) Inventors: Mitsuhiro HATTORI, Tokyo (JP); Yoichi SHIBATA, Tokyo (JP); Takashi ITO, Tokyo (JP); Fumio OMATSU, Tokyo (JP)

(73) Assignee: MITSUBISHI ELECTRIC CORPORATION, Tokyo (JP)

(21) Appl. No.: 16/470,632

(22) PCT Filed: Jan. 27, 2017
(86) PCT No.: PCT/JP2017/002874

§ 371 Date: Jun. 18, 2019

(51) Int. Cl. G06F 21/62; G06F 16/245; H04L 29/06; G06F 21/60; H04L 9/30

(52) U.S. Cl. CPC G06F 21/6254; G06F 21/6272; G06F 16/245; G06F 2221/2117; G06F 21/602; H04L 9/30; H04L 63/0414

(57) ABSTRACT

In a search device (102), a data search unit (233) acquires an encrypted query including one keyword from a data storage unit (232), the encrypted query being stored in the storage unit (232) since before the encrypted data is received by the data reception unit (231). The data search unit (233) determines whether a value of the encrypted data and the keyword of the encrypted query coincide, with both of the encrypted data and the encrypted query remaining encrypted. A data transmission unit (234) transmits identification data indicating an identifier of the encrypted query when it is determined by the data search unit (233) that the value of the encrypted data and the keyword of the encrypted query coincide.

### TECHNICAL FIELD

The present invention relates to a search device, a monitoring device, a monitoring method, and a search program.

### BACKGROUND ART

IoT has been progressing. “IoT” is an abbreviation for Internet of Things. With the development of IoT, it is becoming easier to collect large amounts of sensor data from many sensor devices. Therefore, there is a growing need for realization of new services such as device failure prediction and remote management, by analyzing such data. However, large-scale network resources and computer resources are required to constantly monitor the large amounts of sensor data. It is accordingly difficult for a single business operator to constantly perform monitoring alone. Therefore, it is desirable to outsource the monitoring work to a cloud provider by utilizing a public cloud service. However, the sensor data may include confidential information and personal information, and some protection measures are required. In order to meet this need, various security techniques are studied.

### CITATION LIST

### Patent Literature

Patent Literature 1: WO 2015/063905

Patent Literature 2: WO 2012/157471

Patent Literature 3: JP 2015-99961 A

Patent Literature 4: Japanese Patent No. 5606642

Patent Literature 5: JP 2005-134990 A

Patent Literature 6: JP 2013-152520 A

### Non-Patent Literature

Non-Patent Literature 1: Ken Naganuma, Masayuki Yoshino, Hisayoshi Sato, and Yoshinori Sato, “Privacy-preserving Analysis Technique for Secure, Cloud-based Big Data Analytics”, Hitachi Review, vol. 63, no. 9, pp. 577-583, 2014

Non-Patent Literature 2: Tatsuaki Okamoto and Katsuyuki Takashima, “Fully Secure Functional Encryption with General Relations from the Decisional Linear Assumption”, Crypto 2010, Lecture Notes in Computer Science, vol. 6233, pp. 191-208, 2010

Non-Patent Literature 3: Tatsuaki Okamoto and Katsuyuki Takashima, “Adaptively Attribute-Hiding (Hierarchical) Inner Product Encryption”, Eurocrypt 2012, Lecture Notes in Computer Science, vol. 7237, pp. 591-608, 2012

Non-Patent Literature 4: Reza Curtmola, Juan Garay, Seny Kamara, Rafail Ostrovsky, “Searchable Symmetric Encryption: Improved Definitions and Efficient Constructions”, ACM CCS 2006, pp. 79-88, 2006

### SUMMARY OF INVENTION

### Technical Problem

The data analysis systems disclosed in Patent Literature 1 and Non-Patent Literature 1 are systems that perform correlation analysis using searchable encryption technology, with the data remaining encrypted. The analysis that can be realized with these systems is only correlation analysis. These systems cannot perform threshold value analysis to detect whether data exceeds a threshold, which is required for failure prediction and remote management.

The abnormality detection system disclosed in Patent Literature 2 is a system that detects an abnormality by cooperation of a plurality of industrial control systems. With this system, if there is information to be concealed from another control system, the information is converted into a random code and protected. In this system, a random code is meaningless data and cannot be used for abnormality detection. Therefore, data that is necessary for abnormality detection cannot be concealed.

It is an objective of the present invention to enable detection of data that has a specific value while ensuring confidentiality of the data.

### Solution to Problem

A search device according to an aspect of the present invention includes:

a data reception unit to receive encrypted data having one value;

a data search unit to acquire an encrypted query including one keyword from a storage medium, the encrypted query being stored in the storage medium since before the encrypted data is received by the data reception unit, and to determine whether the value of the encrypted data and the keyword of the encrypted query coincide, with both of the encrypted data and the encrypted query remaining encrypted; and

a data transmission unit to transmit identification data indicating an identifier of the encrypted query when it is determined by the data search unit that the value of the encrypted data and the keyword of the encrypted query coincide.

### Advantageous Effects of Invention

According to the present invention, it is possible to detect encrypted data having a value that coincides with the keyword of an encrypted query, without decoding the encrypted data and the encrypted query. That is, it is possible to detect data having a specific value while securing confidentiality of the data.

### BRIEF DESCRIPTION OF DRAWINGS

FIG. 1 is a block diagram illustrating a configuration of a confidential abnormality detection system according to Embodiment 1.

FIG. 2 is a block diagram illustrating functional configurations of the devices of the confidential abnormality detection system according to Embodiment 1.

FIG. 3 is a block diagram illustrating hardware configurations of the devices of the confidential abnormality detection system according to Embodiment 1.

FIG. 4 is a block diagram illustrating functions of the confidential abnormality detection system according to Embodiment 1.

FIG. 5 is a flowchart illustrating an operation of a monitoring device according to Embodiment 1.

FIG. 6 is a flowchart illustrating an operation of the monitoring device according to Embodiment 1.

FIG. 7 is a table illustrating an example of a plaintext comparison table and an encryption comparison table according to Embodiment 1.

FIG. 8 is a flowchart illustrating an operation of a gateway device according to Embodiment 1.

FIG. 9 is a flowchart illustrating an operation of a search device according to Embodiment 1.

FIG. 10 is a flowchart illustrating an operation of the monitoring device according to Embodiment 1.

FIG. 11 is a block diagram illustrating functions of a confidential abnormality detection system according to Embodiment 2.

FIG. 12 is a flowchart illustrating an operation of a monitoring device according to Embodiment 2.

FIG. 13 is a flowchart illustrating an operation of a monitoring device according to Embodiment 3.

FIG. 14 is a table illustrating an example of a plaintext comparison table and an encryption comparison table according to Embodiment 3.

FIG. 15 is a graph illustrating an example of real data and grasp data according to Embodiment 3.

### DESCRIPTION OF EMBODIMENTS

Embodiments of the present invention will be described hereinafter with reference to drawings. In the drawings, the same or equivalent portions are denoted by the same reference numeral. The description for the same or equivalent portions of the embodiments will be omitted or simplified appropriately. The present invention is not limited to the embodiments described below, and various modifications can be made as necessary. For example, among the embodiments described below, two or more embodiments may be practiced in combination. Alternatively, among the embodiments described below, one embodiment or a combination of two or more embodiments may be partially practiced.

### Embodiment 1

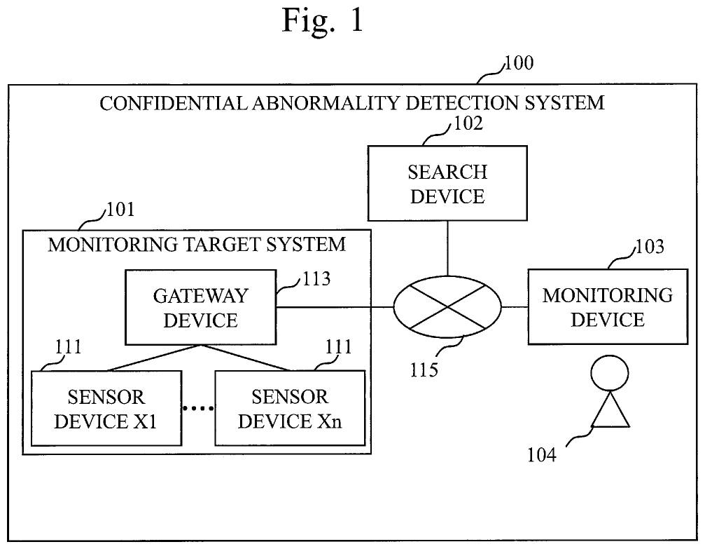

This embodiment will be described using FIGS. 1 to 10.

*** Description of Configuration ***

A configuration of a confidential abnormality detection system 100 according to this embodiment will be described with reference to FIG. 1.

In this embodiment, the confidential abnormality detection system 100 is a system that performs threshold value analysis using public key searchable encryption schemes, with the data remaining encrypted. That is, the confidential abnormality detection system 100 is a system to detect that data exceeds a specific threshold value using public key searchable encryption schemes, with the data remaining encrypted.

Data serving as the target of threshold value analysis may be an arbitrary value, and is power data in this embodiment. The following description uses, as an example, power data which is acquired in one-watt increment from 0 watt to 1,000 watts, the power data signifying abnormality if it is 901 watts or more.

The confidential abnormality detection system 100 is provided with a monitoring target system 101, a search device 102, and a monitoring device 103.

The confidential abnormality detection system 100 is a system being a monitoring target for abnormality detection or the like. Within the monitoring target system 101, there are at least one sensor device 111 and a gateway device 113 for connecting the sensor device 111 to an external network 115 such as the Internet.

The search device 102 is a system to which monitoring work using threshold value analysis is entrusted.

The monitoring device 103 is a system that entrusts the monitoring work. The monitoring device 103 is a system that, upon detection of an abnormality, notifies a maintenance person 104 of the abnormality by display on screen, an alarm sound, or the like.

A configuration is possible in which the sensor device 111 is connected to the external network 115 directly. In such a configuration, the individual sensor device 111 has the same function as that of the gateway device 113 of this embodiment.

A specific application example of the confidential abnormality detection system 100 will be described.

Suppose that the manufacturer entrusts a general cloud service provider with monitoring work. In that case, the monitoring target system 101 is placed in factories in various places. The sensor device 111 is a pressure sensor, an acceleration sensor, or the like, of various types of machines in the factory. The search device 102 is the server of a cloud operated by a cloud service provider. The network 115 is the Internet or a private line. The monitoring device 103 is a terminal such as a smart phone, tablet, mobile phone, and personal computer utilized by the maintenance person 104 of the manufacturer.

Another application example will be described.

Suppose that a general household user entrusts a general cloud service provider with monitoring work. In that case, the monitoring target system 101 is placed at the user's home. The sensor device 111 is a temperature sensor, a power sensor, or the like in the user's home. The search device 102 is the server of a cloud operated by a cloud service provider. The network 115 is the Internet. The monitoring device 103 is a terminal such as a smart phone, tablet, mobile phone, and personal computer utilized by the user.

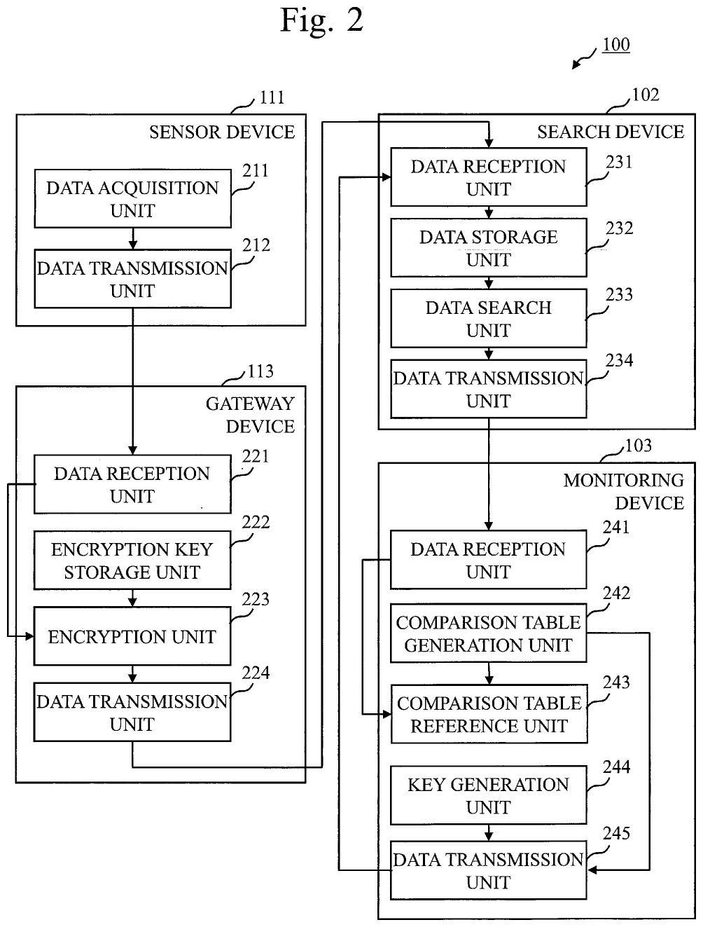

The functional configurations of the devices of the confidential abnormality detection system 100 will be described with reference to FIG. 2.

The sensor device 111 is provided with a data acquisition unit 211 to acquire data and a data transmission unit 212 to transmit the acquired data to the gateway device 113.

The gateway device 113 is provided with a data reception unit 221 to receive data from the sensor device 111, an encryption key storage unit 222 to store an encryption key for encrypting the data, an encryption unit 223 to encrypt the data using the encryption key, and a data transmission unit 224 to transmit the encrypted data to the search device 102.

The search device 102 is provided with a data reception unit 231 to receive data from the gateway device 113 and monitoring device 103, a data storage unit 232 to store the received data, a data search unit 233 to perform data search for the purpose of threshold value analysis, and a data transmission unit 234 to transmit a result obtained by the search to the monitoring device 103.

The monitoring device 103 is provided with a data reception unit 241 to receive the result from the search device 102, a comparison table generation unit 242 to generate a comparison table necessary for confidential abnormality detection, and a comparison table reference unit 243 to calculate an abnormal value by referring to the comparison table based on the received result. The monitoring device 103 is further provided with a key generation unit 244 to generate a key of searchable encryption schemes utilized by the confidential abnormality detection system 100, and a data transmission unit 245 to transmit a comparison table necessary for data search to the search device 102.

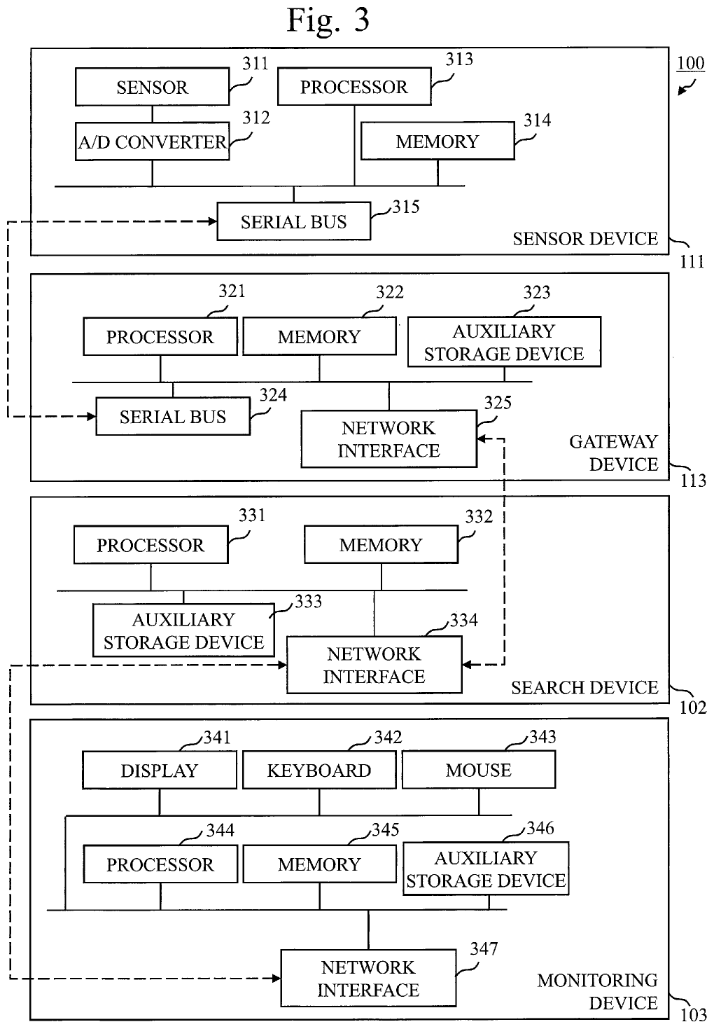

Hardware configurations of the devices of the confidential abnormality detection system 100 will be described with reference to FIG. 3.

The sensor device 111 is a computer. The sensor device 111 is provided with a processor 313 as well as other hardware devices such as a sensor 311, an A/D converter 312, a memory 314, and a serial bus 315. “A/D” is an abbreviation for Analog to Digital. The processor 313 is connected to the other hardware devices via signal lines and controls these other hardware devices.

The function of the data acquisition unit 211 is implemented by software. The function of the data transmission unit 212 is implemented by the serial bus 315.

The sensor 311 is a power sensor, for example. The processor 313 is an IC that performs various types of processes. “IC” is an abbreviation for Integrated Circuit. T general he processor 313 is a CPU, for example. “CPU” is an abbreviation for Central Processing Unit. The memory 314 is a flash memory or RAM, for example. “RAM” is an abbreviation for Random Access Memory.

A program that implements the function of the data acquisition unit 211 is stored in the memory 314 or in a ROM incorporated in the processor 321. This program is executed by a processor 321.

The gateway device 113 is also a computer. The gateway device 113 is provided with the processor 321 as well as other hardware devices such as a memory 322, an auxiliary storage device 323, a serial bus 324, and a network interface 325. The processor 321 is connected to the other hardware devices via signal lines and controls these other hardware devices.

The function of the data reception unit 221 is implemented by the serial bus 324. The function of the encryption key storage unit 222 is implemented by the auxiliary storage device 323. The function of the encryption unit 223 is implemented by software. The function of the data transmission unit 224 is implemented by the network interface 325.

The processor 321 is an IC that performs various types of processes. The processor 321 is a CPU, for example. The memory 322 is a flash memory or RAM, for example. The auxiliary storage device 323 is a flash memory or HDD, for example. “HDD” is an abbreviation for Hard Disk Drive. The network interface 325 is a communication chip or NIC, for example. “NIC” is an abbreviation for Network Interface Card.

An encryption program being a program that implements the function of the encryption unit 223 is stored in the auxiliary storage device 323. The encryption program is loaded to the memory 322 and executed by the processor 321.

The gateway device 113 may be provided with a plurality of processors that replace the processor 321. The plurality of processors share execution of the encryption program. Each processor is an IC that performs various types of processes, as the processor 321 does.

Information, data, signal values, and variable values representing the processing result of the encryption unit 223 are stored in the memory 322, the auxiliary storage device 323, or a register or cache memory in the processor 321.

The encrypted program may be stored in a portable recording medium such as a magnetic disk or optical disk.

The search device 102 is also a computer. The search device 102 is provided with a processor 331 as well as other hardware devices such as a memory 332, an auxiliary storage device 333, and a network interface 334. The processor 331 controls the other hardware devices via signal lines and controls these other hardware devices.

The functions of the data reception unit 231 and data transmission unit 234 are implemented by the network interface 334. The function of the data storage unit 232 is implemented by the auxiliary storage device 333. The function of the data search unit 233 is implemented by software.

The processor 331 is an IC that performs various types of processes. The processor 331 is a CPU, for example. The memory 332 is a flash memory or RAM, for example. The auxiliary storage device 333 is a flash memory or HDD, for example. The network interface 334 is a communication chip or NIC, for example.

A search program being a program that implements the function of the data search unit 233 is stored in the auxiliary storage device 333. The search program is loaded to the memory 332 and executed by the processor 331.

The search device 102 may be provided with a plurality of processors that replace the processor 331. The plurality of processors share execution of the search program. Each processor is an IC that performs various types of processes, as the processor 331 does.

Information, data, signal values, and variable values representing the processing result of the data search unit 233 are stored in the memory 332, the auxiliary storage device 333, or a register or cache memory in the processor 331.

The search program may be stored in a portable recording medium such as a magnetic disk or optical disk.

The monitoring device 103 is also a computer. The monitoring device 103 is provided with a processor 344 as well as other hardware devices such as a display 341, a keyboard 342, a mouse 343, a memory 345, an auxiliary storage device 346, and a network interface 347. The processor 344 controls the other hardware devices via signal lines and controls these other hardware devices.

The functions of the data reception unit 241 and data transmission unit 245 are implemented by the network interface 347. The functions of the comparison table generation unit 242, comparison table reference unit 243, and key generation unit 244 are implemented by software.

The processor 344 is an IC that performs various types of processes. The processor 344 is a CPU, for example. The memory 345 is a flash memory or RAM, for example. The auxiliary storage device 346 is a flash memory or HDD, for example. The network interface 347 is a communication chip or NIC, for example.

A monitoring program being a program that implements the functions of the comparison table generation unit 242, comparison table reference unit 243, and key generation unit 244 is stored in the auxiliary storage device 346. The monitoring program is loaded to the memory 345 and executed by the processor 344.

The monitoring device 103 may be provided with a plurality of processors that replace the processor 344. The plurality of processors share execution of the monitoring program. Each processor is an IC that performs various types of processes, as the processor 44 does.

The display 341 is used for presenting information to the maintenance person 104 or other users. The keyboard 342 and mouse 343 are used by the maintenance person 104 or other users to perform operation.

The monitoring device 103 may be provided with the display 341 and a touch panel that replaces the keyboard 342 and mouse 343.

Information, data, signal values, and variable values representing the processing results of the comparison table generation unit 242, comparison table reference unit 243, and key generation unit 244 are stored in the memory 345, the auxiliary storage device 346, or a register or cache memory in the processor 344.

The monitoring program may be stored in a portable recording medium such as a magnetic disk or optical disk.

*** Description of Operation ***

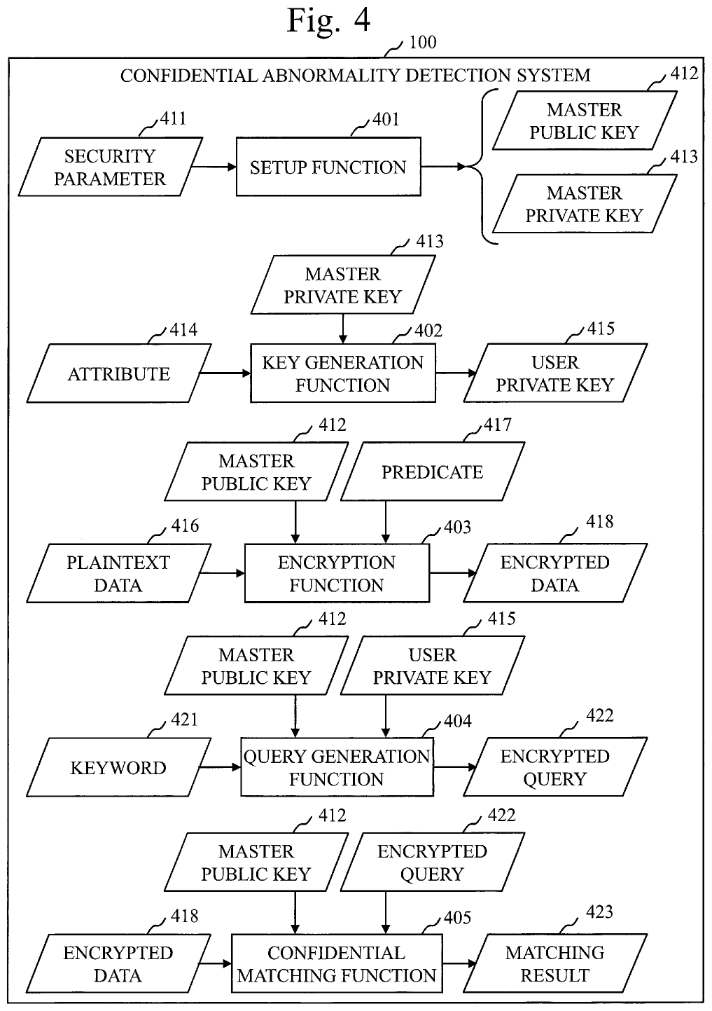

The operation of the confidential abnormality detection system 100 according to this embodiment will be described with reference to FIGS. 4 to 10. The operation of the confidential abnormality detection system 100 corresponds to a monitoring method according to this embodiment.

The function of the confidential abnormality detection system 100 will be described with reference to FIG. 4.

The confidential abnormality detection system 100 has a setup function 401, a key generation function 402, an encryption function 403, a query generation function 404, and a confidential matching function 405, as the functions of public key searchable encryption schemes.

The setup function 401 is a function of receiving the security parameter 411 as input and outputting a master public key 412 and a master private key 413. The security parameter 411 is a parameter that represents security strength by a numerical value such as a bit number. As the security parameter 411, a value such as 80 bits and 128 bits is usually employed.

The key generation function 402 is a function of receiving an attribute 414 and the master private key 413, as input and outputting a user private key 415 corresponding to the attribute 414. The attribute 414 is data representing a user ID and user characteristics. “ID” is an abbreviation for IDentifier. Examples of the user characteristics include affiliation and post. The attribute 414 prescribes the decryption authority for the user private key 415.

The encryption function 403 is a function of receiving plaintext data 416, the master public key 412, and a predicate 417, as input and outputting encrypted data 418. The predicate 417 is data serving as an encryption target in public key searchable encryption schemes. For example, the predicate 417 has a value “901” watts. In the encryption function 403, due to the mechanism of public key searchable encryption schemes, data serving as the encryption target is not the plaintext data 416 but the predicate 417.

The query generation function 404 is a function of receiving a keyword 421, the master public key 412, and the user private key 415, as input and outputting an encrypted query 422. The keyword 421 is data having the same value as the value included in the predicate 417 serving as the search target. For example, the keyword 421 has a value “901”.

The confidential matching function 405 is a function of receiving the encrypted data 418, the master public key 412, and the encrypted query 422, as input and outputting a matching result 423. The matching result 423 is 1-bit information representing whether the predicate 417 included in the encrypted data 418 and the keyword 421 included in the encrypted query 422 coincide. For example, as the matching result 423, “1: hit” is outputted if they coincide; “0: no hit” is outputted if they do not coincide. With the confidential matching function 405, the encrypted data 418 and the encrypted query 422 can be matched without being decrypted.

As for the algorithm to obtain output from input with the above functions, the same algorithm as that of a searchable encryption described in Patent Literature 3, Non-Patent Literature 2, and Non-Patent Literature 3 can be employed.

The operation of the confidential abnormality detection system 100 according to this embodiment includes three phases of: (1) key distribution phase; (2) encryption comparison table registration phase; and (3) confidential abnormality detection phase. These phases will be described in turn.

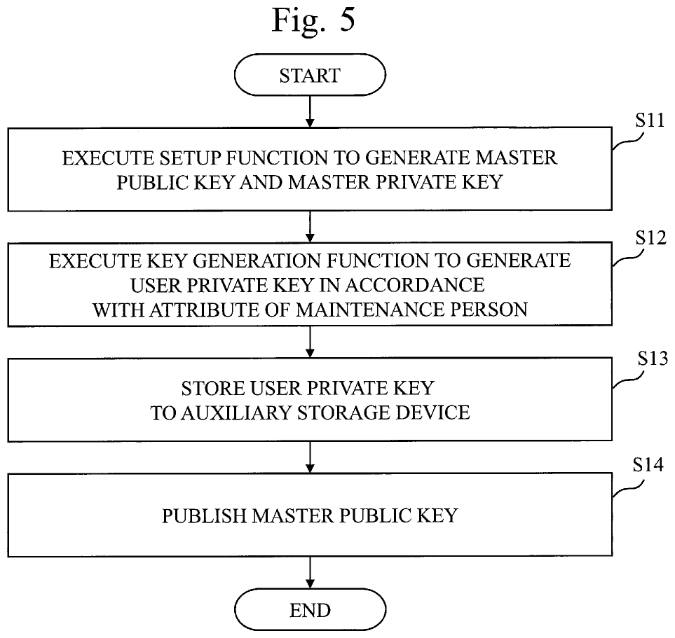

First, the operation of (1) key distribution phase will be described with reference to FIG. 5.

In step S11 of FIG. 5, the key generation unit 244 of the monitoring device 103 executes the setup function 401 of public key searchable encryption schemes to generate the master public key 412 and the master private key 413. The key generation unit 244 then stores the master public key 412 and the master private key 413 to the auxiliary storage device 346.

In step S12 of FIG. 5, the key generation unit 244 the monitoring device 103 acquires the attribute 414 being data representing the user ID and characteristics of the maintenance person 104, based on the setting or the like entered by the maintenance person 104 using the keyboard 342 or mouse 343. Then, at input of the attribute 414 and master private key 413, the key generation unit 244 executes the key generation function 402 of public key searchable encryption schemes to generate the user private key 415 corresponding to the attribute of the maintenance person 104.

In step S13 of FIG. 5, the key generation unit 244 of the monitoring device 103 stores the user private key 415 to the auxiliary storage device 346.

In step S14 of FIG. 5, the key generation unit 244 of the monitoring device 103 publishes the master public key 412. Publication of the master public key 412 is done by broadcasting the master public key 412 by the key generation unit 244 from the data transmission unit 245 to the network 115 and receiving the master public key 412 by both of the gateway device 113 and search device 102. The gateway device 113, upon reception of the master public key 412 via the network interface 325, stores the master public key 412 to the auxiliary storage device 323 being the encryption key storage unit 222. The search device 102, upon reception of the master public key 412 via the network interface 334 being the data reception unit 231, stores the master public key 412 to the auxiliary storage device 333.

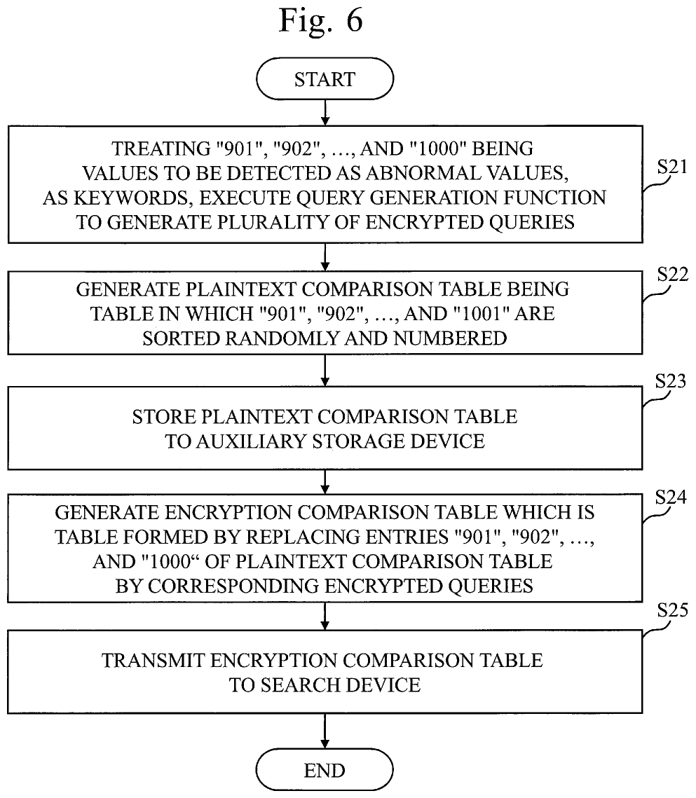

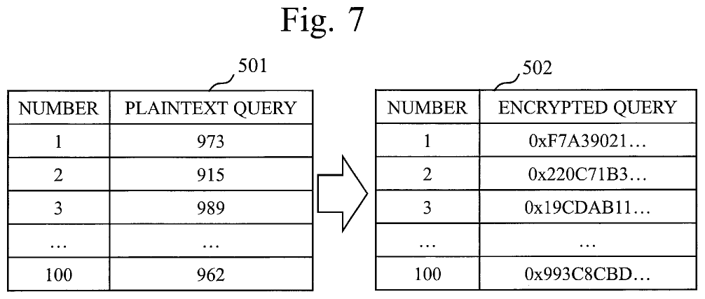

The operation of (2) encryption comparison table registration phase will be described with reference to FIGS. 6 and 7.

As described earlier, the target of threshold value analysis is power data which is acquired in one-watt increment from 0 watt to 1,000 watts and which is abnormal if it is equal to 901 watts or more.

In step S21 of FIG. 6, the comparison table generation unit 242 of the monitoring device 103 extracts the master public key 412 and user private key 415 from the auxiliary storage device 346. The comparison table generation unit 242, treating “901”, “902”, . . . , and “1000” being values to be detected as abnormal values, as the keywords 421 and treating the master public key 412 and user private key 415 as input, executes the query generation function 404 of public key searchable encryption schemes, to generate a plurality of encrypted queries 422. That is, the comparison table generation unit 242 of the monitoring device 103 generates 100 pieces of encrypted queries 422 ranging from the “901” encrypted query 422 to the “1000” encrypted query 422.

In step S22 of FIG. 6, the comparison table generation unit 242 of the monitoring device 103 stores the setting entered by the maintenance person 104 using the keyboard 342 or mouse 343, to the memory 332. The comparison table generation unit 242 then generates a plaintext comparison table 501 as illustrated in FIG. 7 based on the setting. The plaintext comparison table 501 is a table in which “901”, “902”, . . . , and “1001” being the values to be detected as the abnormal values are arranged randomly and numbered “1”, “2”, . . . , and “100”.

In step S23 of FIG. 6, the comparison table generation unit 242 of the monitoring device 103 stores the plaintext comparison table 501 to the auxiliary storage device 346.

In step S24 of FIG. 6, the comparison table generation unit 242 of the monitoring device 103 generates an encryption comparison table 502 as illustrated in FIG. 7. The encryption comparison table 502 is a table formed by replacing entries “901”, “902”, . . . , and “1000” of the plaintext comparison table 501 by corresponding encrypted queries 422. For example, “0xF7A39021 . . . ” stored at number “1” of the encryption comparison table 502 of FIG. 7 is an encrypted query 422 corresponding to “973” watts stored at number “1” of the plaintext comparison table 501 of FIG. 7. Of the plaintext comparison table 501, entries “901”, “902”, . . . , and “1000” will be called plaintext queries.

As the plaintext comparison table 501, it is desirable to use a table in which plaintext queries arranged randomly based on a specific distribution are numbered in sequence. In this embodiment, sorting of the plaintext queries employs a method of extracting values “901” to “1000” based on a uniform distribution without duplicates and numbering the extracted values as “1” to “100” in the extraction order. Arranging the plaintext queries randomly according to the uniform distribution produces an effect that even if the search device 102 sees an encrypted query 422, it is difficult for the search device 102 to assume a corresponding plaintext. Another way of arranging may employ a method of extracting values “901” to “1000” based on a probability distribution according to the frequency of appearance without duplicates such that the values “901” to “1000” line up according to the frequency of appearance in the descending order as much as possible, and numbering the extracted values as “1” to “100” in the extraction order. Arranging the plaintext queries randomly based on the probability distribution according to the frequency of appearance produces an effect that confidential abnormality detection in the confidential abnormality detection phase to be described later is performed at a high speed.

In step S25 of FIG. 6, the comparison table generation unit 242 of the monitoring device 103 transmits the encryption comparison table 502 from the data transmission unit 245 to the search device 102 via the network 115. Upon reception of the encryption comparison table 502 via the network interface 334 being the data reception unit 231, the search device 102 stores the encryption comparison table 502 to the auxiliary storage device 333 being the data storage unit 232.

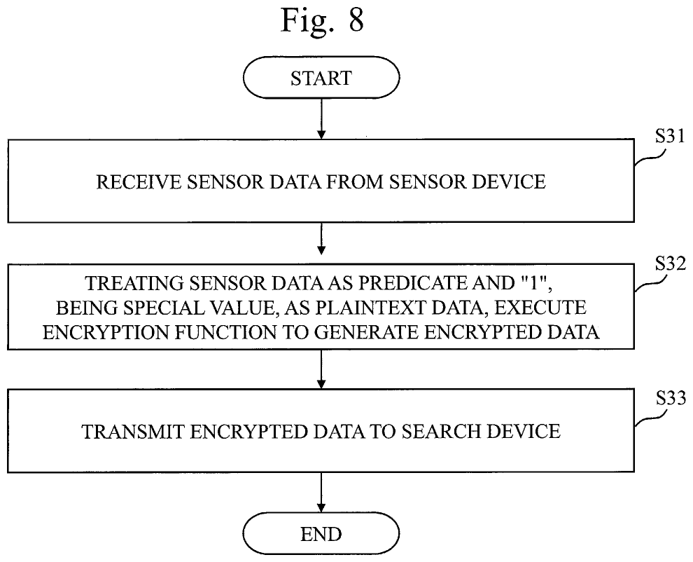

The operation of (3) confidential abnormality detection phase will be described with reference to FIGS. 8, 9, and 10.

Although not illustrated, each time a measurement result is outputted by the sensor 311 in the form of analog data, the data acquisition unit 211 of the sensor device 111 converts the analog data into digital data by the A/D converter 312. The data acquisition unit 211 stores the digital data to the memory 314 as sensor data. The data acquisition unit 211 then transmits the sensor data to the gateway device 113 via the serial bus 315 being the data transmission unit 212.

In step S31 of FIG. 8, the data reception unit 221 of the gateway device 113 receives the sensor data from the sensor device 111. The data reception unit 221 then stores the sensor data to the memory 322.

In step S32 of FIG. 8, the encryption unit 223 of the gateway device 113 extracts the master public key 412 from the auxiliary storage device 323 being the encryption key storage unit 222. The encryption unit 223 reads out the sensor data from the memory 322. The encryption unit 223, treating the sensor data as the predicate 417 and “1” being a special value, as the plaintext data 416 and treating the master public key 412 as input, executes the encryption function 403 of public key searchable encryption schemes, to generate the encrypted data 418. The encryption unit 223 then stores the encrypted data 418 to the memory 322. As described earlier, in the encryption function 403, due to the mechanism of public key searchable encryption schemes, data serving as the encryption target is not the plaintext data 416 but the predicate 417.

In step S33 of FIG. 8, the encryption unit 223 of the gateway device 113 reads out the encrypted data 418 from the memory 322. The encryption unit 223 transmits the encrypted data 418 from the data transmission unit 224 to the search device 102 via the network 115.

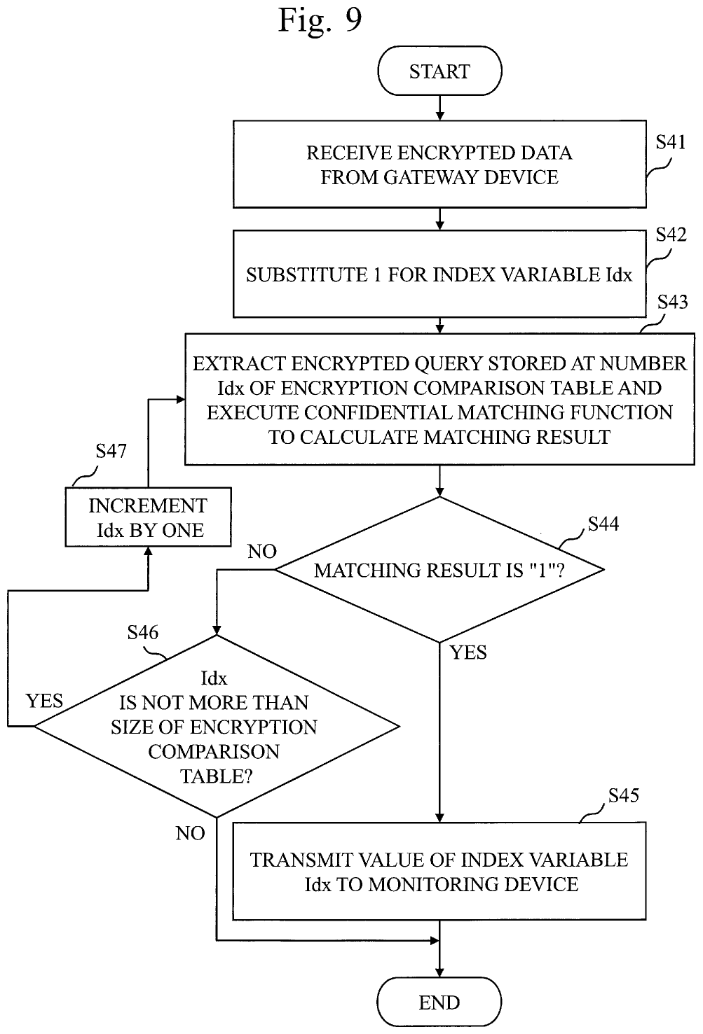

In step S41 of FIG. 9, the data reception unit 231 of the search device 102 receives the encrypted data 418 from the gateway device 113. The data reception unit 231 then stores the encrypted data 418 to the memory 332.

In step S42 of FIG. 9, the data search unit 233 of the search device 102 substitutes 1 for an index variable Idx.

In step S43 of FIG. 9, the data search unit 233 of the search device 102 extracts the master public key 412 from the auxiliary storage device 333. The data search unit 233 reads the encryption comparison table 502 from the auxiliary storage device 333 being the data storage unit 232 onto the memory 332. The data search unit 233 gets an encrypted query 422 stored at number Idx of the encryption comparison table 502. Then, treating the encrypted query 422, the master public key 412, and the encrypted data 418 on the memory 332, as input, the data search unit 233 executes the confidential matching function 405 of public key searchable encryption schemes to calculate the matching result 423. That is, the data search unit 233 executes confidential matching between the encryption comparison table 502 and the encrypted data 418 on the memory 332.

In step S44 of FIG. 9, the data search unit 233 of the search device 102 checks if the matching result 423 is a special value “1”. If “1”, the process of step S45 is performed. If not “1”, the process of S46 is performed.

In step S45 of FIG. 9, the data search unit 233 of the search device 102 transmits identification data indicating the value of the index variable Idx from the data transmission unit 234 to the monitoring device 103 via the network 115. That is, the data search unit 233 transmits an execution result of the confidential matching to the monitoring device 103. After that, processing ends.

In step S46 of FIG. 9, the data search unit 233 of the search device 102 checks if the index variable Idx is not more than the size of the encryption comparison table 502. The size of the encryption comparison table 502 means the total number of rows of the encryption comparison table 502. In the example of FIG. 7, the total number of rows of the encryption comparison table 502 is 100. If the index variable Idx is not more than the size of the encryption comparison table 502, the process of step S47 is performed. If the index variable Idx exceeds the size of the encryption comparison table, processing ends.

In step S47 of FIG. 9, the data search unit 233 of the search device 102 increments the index variable Idx. After that, the process of step S43 is performed again.

As described above, in step S41, the data reception unit 231 receives the encrypted data 418 having one value. In step S43 and step S44, the data search unit 233 acquires the encrypted query 422 including one keyword 421 from the data storage unit 232, the encrypted query 422 being stored in the data storage unit 232 since before the encrypted data 418 is received by the data reception unit 231. The data search unit 233 determines whether the value of the encrypted data 418 and the keyword 421 of the encrypted query 422 coincide, with both of the encrypted data 418 and the encrypted query 422 remaining encrypted. When it is determined by the data search unit 233 that the value of the encrypted data 418 and the keyword 421 of the encrypted query 422 coincide, then in step S45, the data transmission unit 234 transmits identification data indicating the identifier of the encrypted query 422.

The data storage unit 232 is an example of the storing medium. In another example of the storing medium, the memory 332 may replace the data storage unit 232.

It suffices as far as at least one encrypted query 422 is stored in the data storage unit 232. In the data storage unit 232 according to this embodiment, the plurality of encrypted queries 422 including keywords 421 that are different respectively are stored. When it is determined by the data search unit 233 that the value of the encrypted data 418 and a keyword 421 of any one encrypted query 422 among the plurality of encrypted queries 422 coincide, then in step S45, the data transmission unit 234 transmits data indicating an identifier of that one encrypted query 422 as the identification data.

Encrypted queries 422 whose number is equal to or more than the number of values that the encrypted data 418 can take may be stored in the data storage unit 232. In the data storage unit 232 according to this embodiment, encrypted queries 422 whose number is smaller than the number of values that the encrypted data 418 can take are stored. This means that the number of encrypted queries 422 to be stored in the data storage unit 232 is limited to a number that needs notification. According to this embodiment, unnecessary notification can be eliminated.

The value of the encrypted data 418 may be an arbitrary value, and is a numerical value in this embodiment. In this embodiment, the keywords 421 of the plurality of encrypted queries 422 correspond 1-to-1 to a plurality of consecutive numerical values. Therefore, threshold value analysis is possible.

The encryption comparison table 502, being a comparison table of the plurality of encrypted queries 422 and identifiers of the plurality of encrypted queries 422, is stored in the data storage unit 232. In step S43 and step S44, the data search unit 233 acquires the encrypted queries 422 from the encryption comparison table 502 one at a time. Then, the data search unit 233 determines if the value of the encrypted data 418 and the keyword 421 of an acquired encrypted query 422 coincide, with both of the encrypted data 418 and the acquired encrypted query 422 remaining encrypted. When it is determined by the data search unit 233 that the value of the encrypted data 418 and the keyword of one encrypted query 422 coincide, then in step S45, the data transmission unit 234 acquires an identifier of that one encrypted query 422 from the encryption comparison table 502. Then, the data transmission unit 234 transmits data indicating the acquired identifier, as the identification data.

It is desirable that the identifiers of the plurality of encrypted queries 422 be given to the plurality of encrypted queries 422 randomly. In this embodiment, numbers are given as the identifiers, but symbols or any other information may be given as the identifiers.

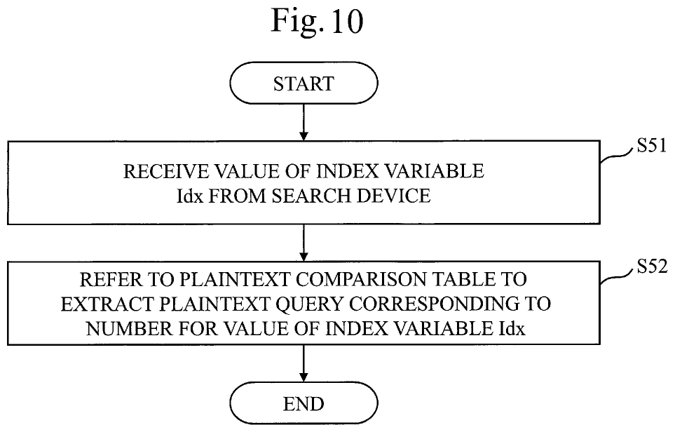

In step S51 of FIG. 10, the data reception unit 241 of the monitoring device 103 receives identification data indicating the value of the index variable Idx from the search device 102. That is, the data reception unit 241 receives an execution result of confidential matching from the search device 102.

In step S52 of FIG. 10, the comparison table reference unit 243 of the monitoring device 103 reads the plaintext comparison table 501 from the auxiliary storage device 346 onto the memory 345. The comparison table reference unit 243 refers to the plaintext comparison table 501 to get a plaintext query corresponding to the number for the value of the index variable Idx. Then, the comparison table reference unit 243 displays the plaintext query onto the display 341 as data indicating an abnormal value corresponding to a notification from the search device 102. The comparison table reference unit 243 may display the value of the index variable Idx onto the display 341 together with the plaintext query.

As described above, according to this embodiment, upon reception of the identification data from the search device 102, the monitoring device 103 refers to the plaintext comparison table 701, being a comparison table of the keywords 421 of the plurality of encrypted queries 422 and identifiers of the plurality of encrypted queries 422, to specify a keyword 421 corresponding to an identifier indicated by the identification data.

As the operation of the confidential abnormality detection system 100 according to this embodiment, three phases of: (1) key distribution phase; (2) encryption comparison table registration phase; and (3) confidential abnormality detection phase have been described in turn.

*** Description of Advantageous Effects of Embodiment ***

The reason why confidential abnormality detection is realized by the series of operations described above will now be described.

The use of this embodiment is threshold value analysis. That is, the objective of this embodiment is to detect that data exceeds a specific threshold value, with the data remaining encrypted. In this embodiment, in order to detect this excess over the threshold value, all values that exceed the threshold value are used as search queries. Thus, when the value of the sensor data exceeds the threshold value, the matching result of one encrypted query 422 by confidential matching is necessarily “1”. On the other hand, when the value of the sensor data is equal to or less than the threshold value, the matching result of no encrypted query 422 is “1”. Therefore, only when the value of the sensor value exceeds the threshold value, the value of the index variable is notified to the monitoring device 103, and the monitoring device 103 can know the value of the sensor data. In this manner, the confidential abnormality detection system 100 can detect that data exceeds a specific threshold value by the series of operations described above, with the data remaining encrypted.

It will now be described that confidential abnormality detection is realized by executing the three phases of: (1) key distribution phase; (2) encryption comparison table registration phase; and (3) confidential abnormality detection phase, which are the operations of the confidential abnormality detection system 100 according to this embodiment, in the order named. Particularly, the effect provided by executing (2) encryption comparison table registration phase, before (3) confidential abnormality detection phase, will be described.

general, when public key searchable encryption schemes is employed, a phase of searching for data is executed after a phase of encrypting the data. The phase of encrypting the data corresponds to step S32 of (3) confidential abnormality detection phase of this embodiment. The phase of searching for data corresponds to step S21 of (2) encryption comparison table registration phase and step S43 of (3) confidential abnormality detection phase, of this embodiment. That is, according to a general order, data encryption is executed first and after that generation of a query to be used in confidential matching is executed. For example, with the technique described in Patent Literature 4, it is supposed that encrypted data already exists and that an encrypted query is generated to search for the encrypted data. Likewise, with the technique described in Patent Literature 5, it is supposed that encrypted data already exists and that an encrypted query is generated to search for the encrypted data.

However, with these techniques, the immediacy that is needed in confidential abnormality detection cannot be achieved. That is, it is not possible to realize a system in which the monitoring device 103 can know occurrence of an abnormality immediately only when the abnormality occurs. This is because in order that threshold value analysis is executed immediately when encrypted sensor data arrives at the search device 102, the encrypted query 422 must be generated before the encrypted data 418 is generated to provide a state where confidential matching is possible. That is, (2) encryption comparison table registration phase, must be executed before (3) confidential abnormality detection phase.

According to this embodiment, (2) encryption comparison table registration phase is executed before (3) confidential abnormality detection phase. Therefore, an effect is produced that the immediacy that is needed in confidential abnormality detection can be achieved. The encrypted query 422 is not only registered but also registered in the form of the encryption comparison table 502. Therefore, another effect is produced that even if the search device 102 sees the encrypted query 422, it is difficult for the search device 102 to assume a corresponding plaintext. Still another effect is also produced that when “1” is calculated by confidential matching, the monitoring device 103 can know the value of the sensor data. These effects cannot be obtained by merely changing the order of the phases of public key searchable encryption schemes but can only be obtained by the use of the encryption comparison table 502 and plaintext comparison table 501 of this embodiment.

As has been described above, according to this embodiment, it is possible to detect that data exceeds a specific threshold value using public key searchable encryption schemes, with the data remaining encrypted.

This embodiment is advantageous in that, since public key searchable encryption schemes is employed, encryption of sensor data can be achieved by any one. This embodiment has an effect that it can cope with a case where the confidential abnormality detection system 100 involves various entities, as in a case where the operating company of the monitoring device 103 and the operating company of the monitoring target system 101 are different.

According to the present invention, it is possible to detect encrypted data 418 having a value that coincides with the keyword 421 of the encrypted query 422, without decoding the encrypted data 418 and the encrypted query 422. That is, it is possible to detect data having a specific value while securing confidentiality of the data. More specifically, data analysis such as threshold value analysis, which is necessary for failure prediction and remote management, becomes possible while securing confidentiality of data. In particular, it is possible to realize a system equipped with immediacy that is needed in abnormal detection, that is, a system that enables an abnormality to be known at once as soon as it occurs, without delay.

*** Other Configurations ***

Suppose that data used for abnormality detection are few. That is, suppose that the size of the encryption comparison table 502 is small. In that case, there is a possibility that the search device 102 can predict easily what data is used. In view of this, it is effective to increase the size of data of the encryption comparison table 502 by intentionally using dummy data. That is, if the size of the encryption comparison table 502 is increased by adding a dummy query, then even when data used for abnormality detection are few, it is possible to make it difficult for the search device 102 to predict what data is used.

In this embodiment, the sensor device 111 and the gateway device 113 are connected to each other via a serial bus. A modification may be possible where a sensor device 111 and a gateway device 113 are connected to each other via a network such as Ethernet (registered trademark).

In this embodiment, the function of the encryption unit 223 of the gateway device 113 is implemented by software. A modification may be possible where the function of an encryption unit 223 is implemented by a combination of software and hardware. That is, part of the function of the encryption unit 223 may be implemented by a dedicated electronic circuit, and the remaining part of the function may be implemented by software.

In this embodiment, the function of the data search unit 233 of the search device 102 is implemented by software. A modification may be possible where the function of a data search unit 233 is implemented by a combination of software and hardware. That is, part of the function of the data search unit 233 may be implemented by a dedicated electronic circuit, and the remaining part of the function may be implemented by software.

In this embodiment, the functions of the comparison table generation unit 242, comparison table reference unit 243, and key generation unit 244 of the monitoring device 103 are implemented by software. A modification may be possible where the functions of a comparison table generation unit 242, comparison table reference unit 243, and key generation unit 244 are implemented by a combination of software and hardware. That is, some of the functions of the comparison table generation unit 242, comparison table reference unit 243, and key generation unit 244 may be implemented by a dedicated electronic circuit, and the remaining functions may be implemented by software.

The dedicated electronic circuit is, for example, a single circuit, a composite circuit, a programmed processor, a parallel-programmed processor, a logic IC, a GA, an FPGA, or an ASIC. Note that “GA” is an abbreviation for Gate Array, that “FPGA” is an abbreviation for Field-Programmable Gate Array, and that “ASIC” is an abbreviation for Application Specific Integrated Circuit.

The processor, the memory, and the dedicated electronic circuit are collectively called “processing circuitry”. That is, regardless of whether the function of the encryption unit 223 of the gateway device 113 may be implemented by software or a combination of software and hardware, the function of the encryption unit 223 is implemented by processing circuitry. Regardless of whether the function of the data search unit 233 of the search device 102 may be implemented by software or a combination of software and hardware, the function of the data search unit 233 is implemented by processing circuitry. Regardless of whether the functions of the comparison table generation unit 242, comparison table reference unit 243, and key generation unit 244 of the monitoring device 103 may be implemented by software or a combination of hardware and software, the functions of the comparison table generation unit 242, comparison table reference unit 243, and key generation unit 244 are implemented by processing circuitry.

### Embodiment 2

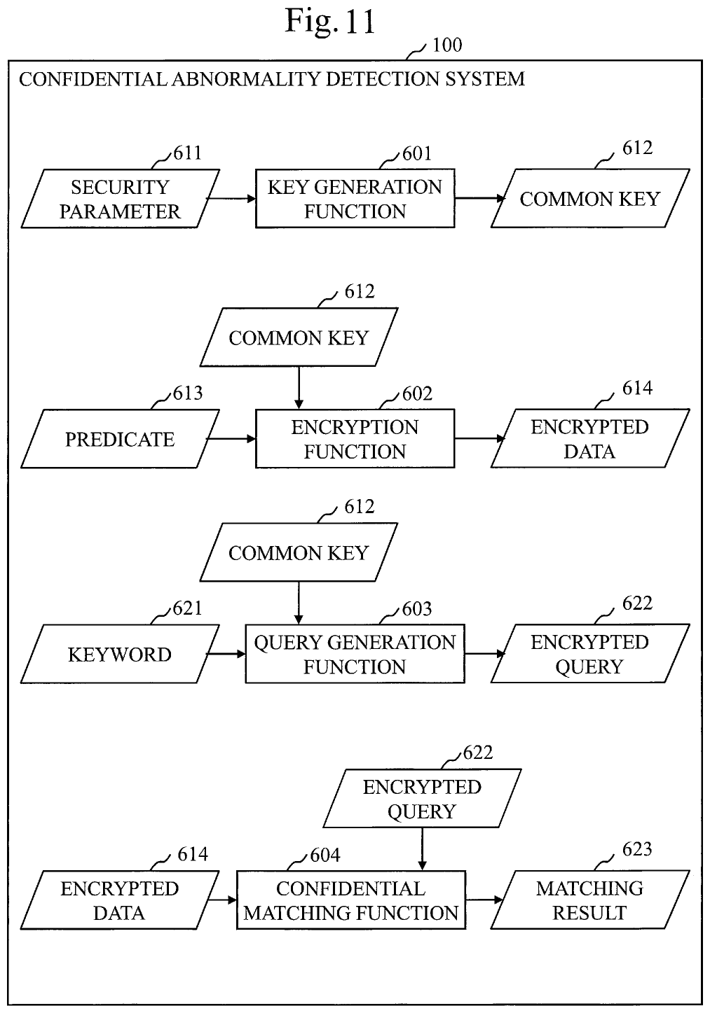

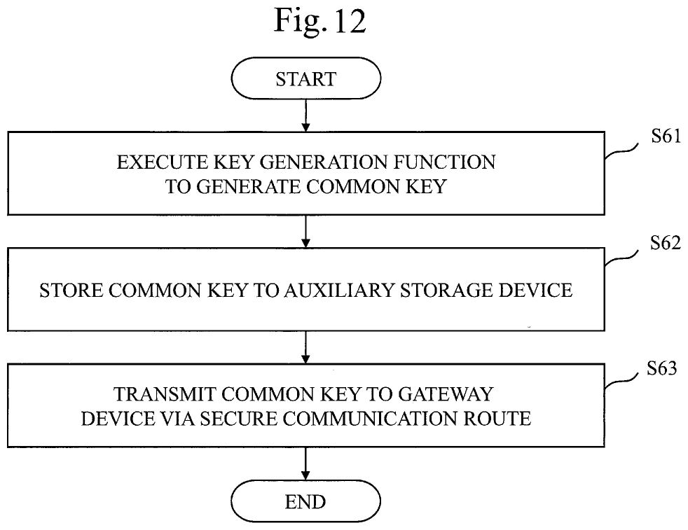

This embodiment will be described mainly by its differences from Embodiment 1 with reference to FIGS. 11 and 12.

*** Description of Configuration ***

A configuration of a confidential abnormality detection system 100 according to this embodiment is the same as that of Embodiment 1 illustrated in FIG. 1.

In Embodiment 1, the confidential abnormality detection system 100 is a system that performs threshold value analysis using public key searchable encryption schemes, with data remaining encrypted. In contrast to this, the confidential abnormality detection system 100 according to this embodiment is a system that performs threshold value analysis using common key searchable encryption schemes, with data remaining encrypted. That is, the confidential abnormality detection system 100 is a system that detects excess of data over a specific threshold value using common key searchable encryption schemes, with the data remaining encrypted.

The functional configurations and hardware configurations of the devices of the confidential abnormality detection system 100 are the same as those of Embodiment 1 illustrated in FIGS. 2 and 3, respectively.

*** Description of Operation ***

The operation of the confidential abnormality detection system 100 according to this embodiment will be described with reference to FIGS. 11 and 12. The operation of the confidential abnormality detection system 100 corresponds to a monitoring method according to this embodiment.

The function of the confidential abnormality detection system 100 will be described with reference to FIG. 11.

The confidential abnormality detection system 100 has a key generation function 601, an encryption function 602, a query generation function 603, and a confidential matching function 604, as the functions of common key searchable encryption schemes.

The key generation function 601 is a function of receiving a security parameter 611 as input and outputting a common key 612. The security parameter 611 is data that represents a security strength by a numerical value such as a bit number. As the security parameter 611, a value such as 80 bits and 128 bits is usually employed.

The encryption function 602 is a function of receiving the common key 612 and a predicate 613, as input and outputting encrypted data 614. The predicate 613 is data basically serving as a search target. For example, the predicate 613 has a value “901” watts.

The query generation function 603 is a function of receiving a keyword 621 and the common key 612, as input and outputting an encrypted query 622. The keyword 621 is data having the same value as the value included in the predicate 613 serving as the search target. For example, the keyword 621 has a value “901”.

The confidential matching function 604 has a function of receiving the encrypted data 614 and encrypted query 622, as input and outputting a matching result 623. The matching result 623 is 1-bit information representing whether the predicate 613 included in the encrypted data 614 and the keyword 621 included in the encrypted query 622 coincide. For example, as the matching result 623, “1: hit” is outputted if they coincide; “0: no hit” is outputted if they do not coincide. With the confidential matching function 604, the encrypted data 614 and the encrypted query 622 can be matched without being decrypted.

As for the algorithm to obtain output from input with the above functions, the same algorithm as that of a search encryption described in Non-Patent Literature 4 and Patent Literature 6 can be employed.

The operation of the confidential abnormality detection system 100 according to this embodiment includes three phases of: (1) key distribution phase; (2) encryption comparison table registration phase; and (3) confidential abnormality detection phase. Since the encryption schemes that is employed in these phases is common key searchable encryption schemes, the operation of this embodiment is somewhat different, particular in (1) key distribution.

The operation of (1) key distribution will be described with reference to FIG. 12.

In step S61 of FIG. 12, a key generation unit 244 of a monitoring device 103 executes the key generation function 601 of common key searchable encryption schemes to generate the common key 612.

In step S62 of FIG. 12, the key generation unit 244 the monitoring device 103 stores the common key 612 to an auxiliary storage device 346.

In step S63 of FIG. 12, the key generation unit 244 of the monitoring device 103 transmits the common key 612 to a gateway device 113 via a secure communication route. As the secure communication route, a private line is used. The common key 612 may be transmitted to the gateway device 113 by encrypted communication such as TLS communication. The common key 612 may be provided to the gateway device 113 by physically transporting a medium storing the common key 612. “TLS” is an abbreviation for Transport Layer Security.

Regarding the operations of the remaining phases of: (2) encryption comparison table registration phase; and (3) confidential abnormality detection phase, their only difference from Embodiment 1 is whether they use public key searchable encryption schemes or common key searchable encryption schemes, and accordingly their description will be omitted.

*** Description of Advantageous Effects of Embodiment ***

This embodiment employs common key searchable encryption schemes which is capable of computation at a higher speed than public key searchable encryption schemes. This produces an effect that confidential abnormality detection is performed at a higher speed than in Embodiment 1.

### Embodiment 3

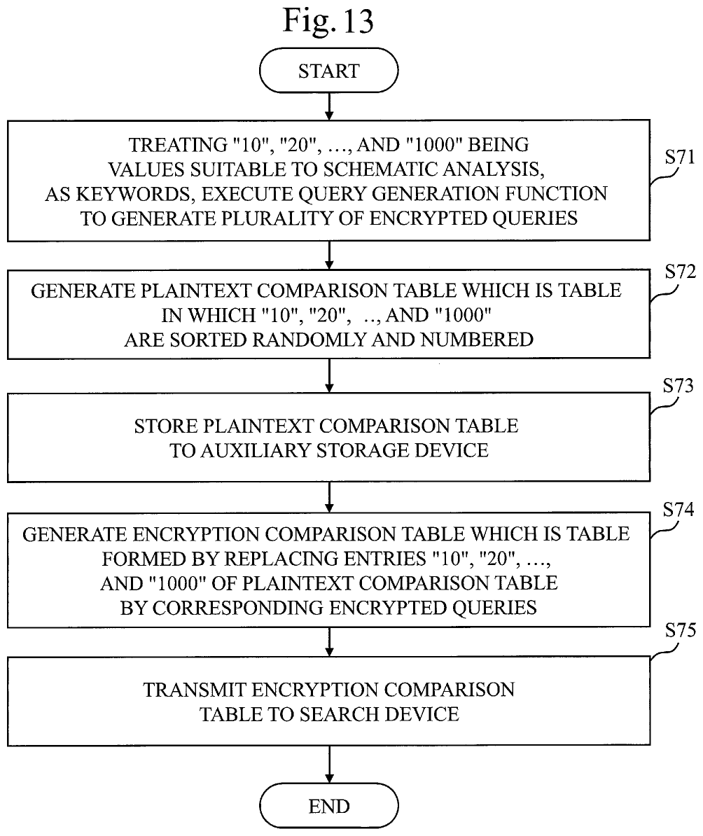

This embodiment will be described mainly by its differences from Embodiment 1 with reference to FIGS. 13 to 15.

*** Description of Configuration ***

A configuration of a confidential abnormality detection system 100 according to this embodiment is the same as that of Embodiment 1 illustrated in FIG. 1.

In Embodiment 1, the confidential abnormality detection system 100 is a system that performs threshold value analysis using public key searchable encryption schemes, with data remaining encrypted. In contrast to this, the confidential abnormality detection system 100 according to this embodiment is a system that performs schematic analysis of data waveform using public key searchable encryption schemes, with data remaining encrypted. That is, the confidential abnormality detection system 100 is a system that analyzes the schematic shape of the waveform of data using public key searchable encryption schemes, with the data remaining encrypted. In place of public key searchable encryption schemes, common key searchable encryption schemes may be employed as in Embodiment 2.

Data serving as the target of schematic analysis of data waveform may be arbitrary data, and is power data in this embodiment. The following description uses, as an example, power data which is acquired in one-watt increment from 0 watt to 1,000 watts.

The functional configurations and hardware configurations of the devices of the confidential abnormality detection system 100 are the same as those of Embodiment illustrated in FIGS. 2 and 3, respectively.

*** Description of Operation ***

The operation of the confidential abnormality detection system 100 according to this embodiment will be described with reference to FIGS. 13 go 15. The operation of the confidential abnormality detection system 100 corresponds to a monitoring method according to this embodiment.

The operation of the confidential abnormality detection system 100 according to this embodiment includes three phases of: (1) key distribution phase; (2) encryption comparison table registration phase; and (3) confidential abnormality detection phase, as in Embodiment 1. The operations of: (1) key distribution phase; and (3) confidential abnormality detection phase, among these phases, are the same as those of Embodiment 1 and accordingly their descriptions will be omitted.

The operation of (2) encryption comparison table registration phase will be described with reference to FIGS. 13 to 15.

As described earlier, the target of schematic analysis of data waveform is power data which is acquired in one-watt increment from 0 watt to 1,000 watts.

In step S71 of FIG. 13, a comparison table generation unit 242 of a monitoring device 103 extracts a master public key 412 and a user private key 415 from an auxiliary storage device 346. The comparison table generation unit 242, treating “10”, “20”, . . . , and “1000” being values suitable to schematic analysis, as keywords 421 and treating the master public key 412 and user private key 415 as input, executes a query generation function 404 of public key searchable encryption schemes, to generate a plurality of encrypted queries 422. That is, the comparison table generation unit 242 of the monitoring device 103 generates 100 pieces of encrypted queries 422 ranging from the “10” encrypted query 422 to the “1000” encrypted query 422.

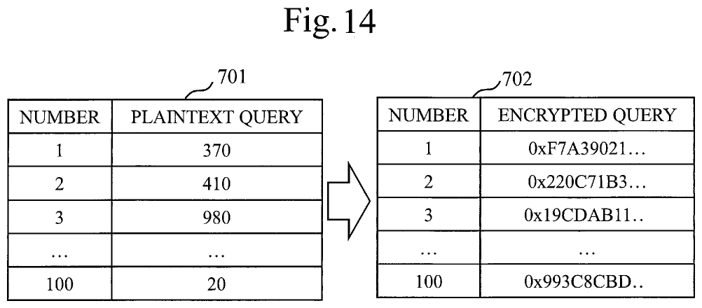

In step S72 of FIG. 13, the comparison table generation unit 242 of the monitoring device 103 stores the setting entered by a maintenance person 104 using a keyboard 342 or mouse 343, to a memory 332. The comparison table generation unit 242 then generates plaintext comparison table 701 as illustrated in FIG. 14 based on the setting. The plaintext comparison table 701 is a table in which “10”, “20”, . . . , and “1000” being values suitable for schematic analysis are arranged randomly and are numbered “1”, “2”, . . . , and “100”.

In step S73 of FIG. 13, the comparison table generation unit 242 of the monitoring device 103 stores the plaintext comparison table 701 to an auxiliary storage device 346.

In step S74 of FIG. 13, the comparison table generation unit 242 of the monitoring device 103 generates an encryption comparison table 702 as illustrated in FIG. 14. The encryption comparison table 702 is a table formed by replacing entries “10”, “20”, . . . , and “1000” of the plaintext comparison table 701 by corresponding encrypted queries 422. For example, “0xF7A39021 . . . ” stored at number “1” of the encryption comparison table 702 of FIG. 14 is an encrypted query 422 corresponding to “370” watts stored at number “1” of the plaintext comparison table 701 of FIG. 14. Of the plaintext comparison table 701, entries “10”, “20”, . . . , and “1000” will be called plaintext queries.

As the plaintext comparison table 701, it is desirable to use a table in which plaintext queries arranged randomly based on a specific distribution are numbered in sequence, as in the plaintext comparison table 501 of Embodiment 1.

In step S75 of FIG. 13, the comparison table generation unit 242 of the monitoring device 103 transmits the encryption comparison table 702 from a data transmission unit 245 to a search device 102 via a network 115. Upon reception of the encryption comparison table 702 via a network interface 334 being a data reception unit 231, the search device 102 stores the encryption comparison table 702 to an auxiliary storage device 333 being a data storage unit 232.

The value of encrypted data 418 may be an arbitrary value, and is a numerical value in this embodiment. Different from Embodiment 1, in this embodiment, the keywords 421 of the plurality of encrypted queries 422 correspond 1-to-1 to a plurality of non-consecutive numerical values. Therefore, schematic analysis of data waveform is possible.

*** Description of Advantageous Effects of Embodiment ***

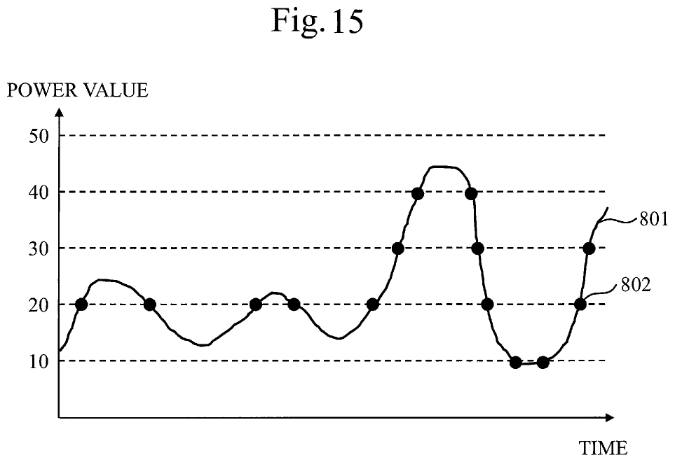

This embodiment provides an effect that schematic analysis of data waveform can be performed with data remaining encrypted. This effect will be understood from the example of FIG. 15.

FIG. 15 illustrates an example of real data 801 and grasp data 802. The grasp data 802 is data grasped based on the real data 801 according to this embodiment.

In the example of FIG. 15, the real data 801 represents a time-base transition of power waveform. This real data 801 is acquired by a sensor device 111 and digitized, and after that encrypted by a gateway device 113. The grasp data 802 indicated by black dots is data which is grasped by a monitoring device 103 according to this embodiment. As is apparent from FIG. 15, in this embodiment, not all of the values monitored by the sensor device 111 are grasped by the monitoring device 103, but only values that are registered in the plaintext comparison table 701 and encryption comparison table 702 are grasped. Therefore, it is possible to grasp data waveform schematically while suppressing the amount of data to be grasped by the monitoring device 103. In this manner, the confidential abnormality detection system 100 can analyze the schematic shape of the waveform of data by the series of operations described above, with the data remaining encrypted.

### REFERENCE SIGNS LIST

100: confidential abnormality detection system; 101: monitoring target system; 102: search device; 103: monitoring device; 104: maintenance person; 111: sensor device; 113: gateway device; 115: network; 211: data acquisition unit; 212: data transmission unit; 221: data reception unit; 222: encryption key storage unit; 223: encryption unit; 224: data transmission unit; 231: data reception unit; 232: data storage unit; 233: data search unit; 234: data transmission unit; 241: data reception unit; 242: comparison table generation unit; 243: comparison table reference unit; 244: key generation unit; 245: data transmission unit; 311: sensor; 312: A/D converter; 313: processor; 314: memory; 315: serial bus; 321: processor; 322: memory; 323: auxiliary storage device; 324: serial bus; 325: network interface; 331: processor; 332: memory; 333: auxiliary storage device; 334: network interface; 341: display; 342: keyboard; 343: mouse; 344: processor; 345: memory; 346: auxiliary storage device; 347: network interface; 401: setup function; 402: key generation function; 403: encryption function; 404: query generation function; 405: confidential matching function; 411: security parameter; 412: master public key; 413: master private key; 414: attribute; 415: user private key; 416: plaintext data; 417: predicate; 418: encrypted data; 421: keyword; 422: encrypted query; 423: matching result; 501: plaintext comparison table; 502: encryption comparison table; 601: key generation function; 602: encryption function; 603: query generation function; 604: confidential matching function; 611: security parameter; 612: common key; 613: predicate; 614: encrypted data; 621: keyword; 622: encrypted query; 623: matching result; 701: plaintext comparison table; 702: encryption comparison table; 801: real data; 802: grasp data

1-10. (canceled)

11. A search device comprising:
processing circuitry
to receive, from a monitoring device which generates an encrypted query including one keyword, the encrypted query and to store the encrypted query in a storage medium, and since then to receive, from another device which is different from the monitoring device and which creates encrypted data having one value, the encrypted data;
to acquire the encrypted query from the storage medium, each time the encrypted data is received, and to determine whether the value of the encrypted data and the keyword of the encrypted query coincide, with both of the encrypted data and the encrypted query remaining encrypted; and
to transmit, to the monitoring device, identification data indicating an identifier of the encrypted query when it is determined that the value of the encrypted data and the keyword of the encrypted query coincide.

12. The search device according to claim 11,
wherein the processing circuitry
receives, as the encrypted query, from the monitoring device, an encrypted query which is generated by the monitoring device, by encrypting the one keyword using a private key stored in the monitoring device and a public key distributed to the another device and the search device and
receives, from the another device, an encrypted data, as the encrypted data, which is generated, by the another device, by encrypting the one value using the public key, and
wherein the processing circuitry determines whether the value of the encrypted data and the keyword of the encrypted query coincide using the public key, with both of the encrypted data and the encrypted query remaining encrypted.

13. The search device according to claim 11,
wherein the processing circuitry receives, from the monitoring device, a plurality of encrypted queries including keywords that are different respectively, each as the encrypted query, and stores in the storage medium, and
wherein when it is determined that the value of the encrypted data and a keyword of any one encrypted query among the plurality of encrypted queries coincide, the processing circuitry transmits data indicating an identifier of said one encrypted query as the identification data.

14. The search device according to claim 13,
wherein the processing circuitry receives, from the monitoring device, encrypted queries whose number is smaller than a number of values that the encrypted data can take as the plurality of encrypted queries and stores medium.

15. The search device according to claim 14,
wherein the value of the encrypted data is a numerical value, and
wherein the keywords of the plurality of encrypted queries correspond 1-to-1 to a plurality of consecutive numerical values.

16. The search device according to claim 14,
wherein the value of the encrypted data is a numerical value, and
wherein the keywords of the plurality of encrypted queries correspond 1-to-1 to a plurality of non-consecutive numerical values.

17. The search device according to claim 13,
wherein the processing circuitry receives an encryption comparison table, being a comparison table of the plurality of encrypted queries and identifiers of the plurality of encrypted queries, and stores in the storage medium, and since then receives the encrypted data from the another device,
wherein the processing circuitry acquires encrypted queries from the encryption comparison table one at a time, and determines if the value of the encrypted data and a keyword of an acquired encrypted query coincide, with both of the encrypted data and the acquired encrypted query remaining encrypted, and
wherein when it is determined that the value of the encrypted data and the keyword of said one encrypted query coincide, the processing circuitry acquires an identifier of said one encrypted query from the encryption comparison table, and transmits, to the monitoring device, data indicating the acquired identifier, as the identification data.

18. The search device according to claim 17,
wherein the identifiers of the plurality of encrypted queries are given to the plurality of encrypted queries randomly.

19. A monitoring system comprising:
a monitoring device
to generate a plaintext comparison table, being a comparison table of the keywords of the plurality of encrypted queries including keywords that are different respectively and identifiers of the plurality of encrypted queries, and
to generate an encryption comparison table, being a comparison table of the plurality of encrypted queries and identifiers of the plurality of encrypted queries,
to transmits the encryption comparison table, and
a search device
to receive, from the monitoring device, the encryption comparison table, and to store in a storage medium,
since then, each time the encrypted data having one value is received from the another device different from the monitoring device, to acquire encrypted queries from the encryption comparison table one at a time, and determines if the value of the encrypted data and a keyword of an acquired encrypted query coincide, with both of the encrypted data and the acquired encrypted query remaining encrypted, and when it is determined that the value of the encrypted data and the keyword of any one encrypted query among the plurality of encrypted queries coincide, to acquire an identifier of said one encrypted query from the encryption comparison table, and to transmit data indicating the acquired identifier, as an identification data,
wherein the monitoring device, upon reception of the identification data from the search device, refers to the plaintext comparison table to specify a keyword corresponding to an identifier indicated by the identification data.

20. A non-transitory computer readable medium storing a search program that causes a computer to execute:
a process of receiving, from a monitoring device which generates an encrypted query including one keyword, the encrypted query and stores the encrypted query in a storage medium, and since then receiving, from another device which is different from the monitoring device and create encrypted data having one value, the encrypted data;
a process of acquiring the encrypted query from the storage medium, each time the encrypted data is received, and determining whether the value of the encrypted data and the keyword of the encrypted query coincide, with both of the encrypted data and the encrypted query remaining encrypted; and
a process of transmitting, to the monitoring device, identification data indicating an identifier of the encrypted query when it is determined that the value of the encrypted data and the keyword of the encrypted query coincide.
